(19) United States
(12) Patent Application Publication
(10) Pub. No.: US 2009/0299951 A1
(43) Pub. Date: Dec. 3, 2009

(54) FAILURE-HANDLING PROCEDURE KNOWLEDGE FORMING APPARATUS AND METHOD THEREOF

(75) Inventors: Yukihiro Watanabe, Kawasaki (JP); Yasuhide Matsumoto, Kawasaki (JP); Kuniaki Shimada, Kawasaki (JP); Yuji Wada, Kawasaki (JP); Masazumi Matsubara, Kawasaki (JP); Kenji Morimoto, Kawasaki (JP); Hiroshi Otsuka, Kawasaki (JP); Akira Katsuno, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/360,658

(22) Filed: Jan. 27, 2009

(30) Foreign Application Priority Data
May 30, 2008 (JP) 2008-142843

(51) Int. Cl. G06N 5/02

(52) U.S. Cl. 706/61

(57) ABSTRACT

A computer-readable storage medium contains instructions. The instructions, when executed by a computer, cause the computer to perform generating a new trouble-handling knowledge by using information regarding a work history read from a work-history storage unit that stores the information regarding the work history; and adding the new trouble-handling knowledge to an existing trouble-handling knowledge.

### CROSS-REFERENCE TO RELATED APPLICATION

This application is based upon and claims the benefit of priority of the prior Japanese Patent Application No. 2008-142843, filed on May 30, 2008, the entire contents of which are incorporated herein by reference.

### FIELD

The embodiments discussed herein are directed to a new failure-handling procedure knowledge forming program, new failure-handling procedure knowledge forming apparatus, and new failure-handling procedure knowledge forming method of adding a new trouble-handling knowledge.

### BACKGROUND

Conventionally, in handling a failure as part of operation management jobs of an Information Technology (IT) system, it has been known to form a knowledge of a previous failure-handling procedure and store the knowledge in a database. For example, when a trouble occurs and its symptom is input, “trouble-handling knowledge” in which an action to be taken to the input symptom is described is sequentially output (refer to Japanese Laid-open Patent Publication No. 05-307484).

Here, for example, when a new product is introduced or new bug is discovered, it is required to add a new trouble-handling knowledge to the database in which trouble-handling knowledge is stored (hereinafter, trouble-handling knowledge DB).

Specifically, if no existing trouble-handling knowledge is found in the trouble-handling knowledge DB (see (1) of FIG. 11), an operation manager handles the trouble as a new trouble (see (2) of FIG. 11), and then prepares a procedure document for handling the new trouble (see (3) of FIG. 11). Then, a new trouble-handling knowledge is formed from the created procedure document (see (4) of FIG. 11) and is added to the trouble-handling knowledge DB (see (5) of FIG. 11).

Meanwhile, in the technology of adding a new trouble-handling knowledge to the trouble-handling knowledge DB, a procedure document for handling the new trouble has to be created by the operation manger. Therefore, the operation manager is disadvantageously required to understand the trouble-handling knowledge in detail and also to take much time and effort.

### SUMMARY

According to an aspect of the invention, a computer-readable storage medium contains instructions. The instructions, when executed by a computer, cause the computer to perform generating a new trouble-handling knowledge by using information regarding a work history read from a work-history storage unit that stores the information regarding the work history; adding the new trouble-handling knowledge to an existing trouble-handling knowledge.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of the configuration of a new failure-handling procedure knowledge forming apparatus according to a first embodiment;

FIG. 2 is a drawing for explaining a process of a work-history recording unit;

FIG. 3 is a drawing for explaining a process of a work-history knowledge forming unit;

FIG. 4 is a drawing for explaining a process of a knowledge adding unit;

FIG. 5 is a drawing for explaining a process of the knowledge adding unit;

FIG. 6 is a drawing for explaining a process of the knowledge adding unit;

FIG. 7 is a drawing for explaining a process of forming a knowledge of a new trouble-handling procedure;

FIG. 8 is a drawing for explaining a process of forming a knowledge of a new trouble-handling procedure;

FIG. 9 is a flowchart for explaining a process operation of the new failure-handling procedure knowledge forming apparatus according to the first embodiment;

FIG. 10 is a drawing of a computer that executes a new failure-handling procedure knowledge forming program; and

FIG. 11 is a drawing for explaining a conventional technology.

### DESCRIPTION OF EMBODIMENTS

Preferred embodiments of the present invention will be explained with reference to accompanying drawings.

### First Embodiment

In the following embodiment, the configuration of a new failure-handling procedure knowledge forming apparatus according to a first embodiment and a flow of process thereof are sequentially explained and, lastly, effects according to the first embodiment are explained.

[Configuration of the New Failure-Handling Procedure Knowledge Forming Apparatus]

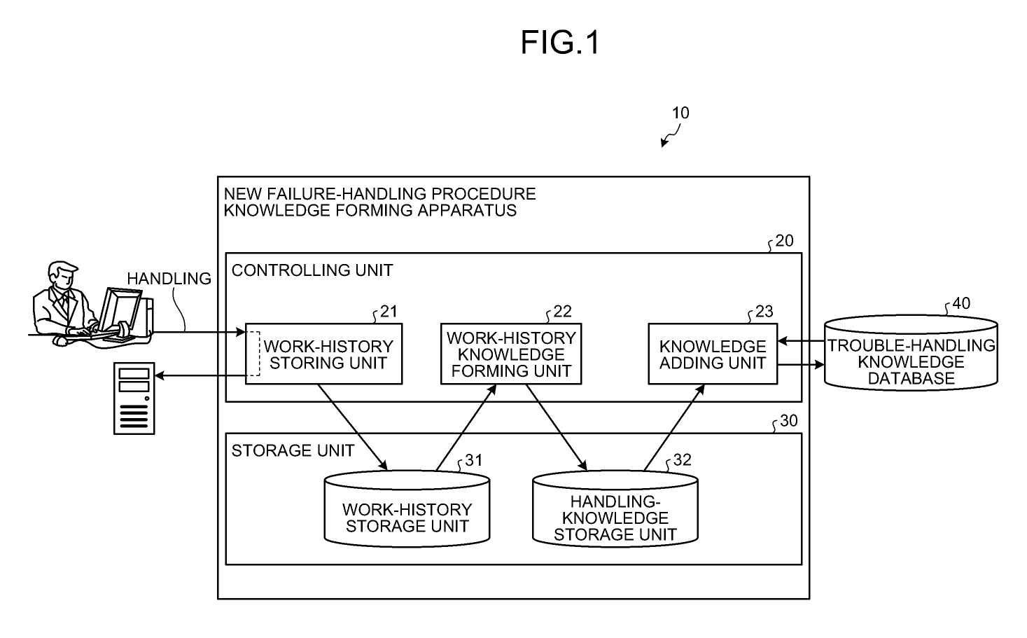

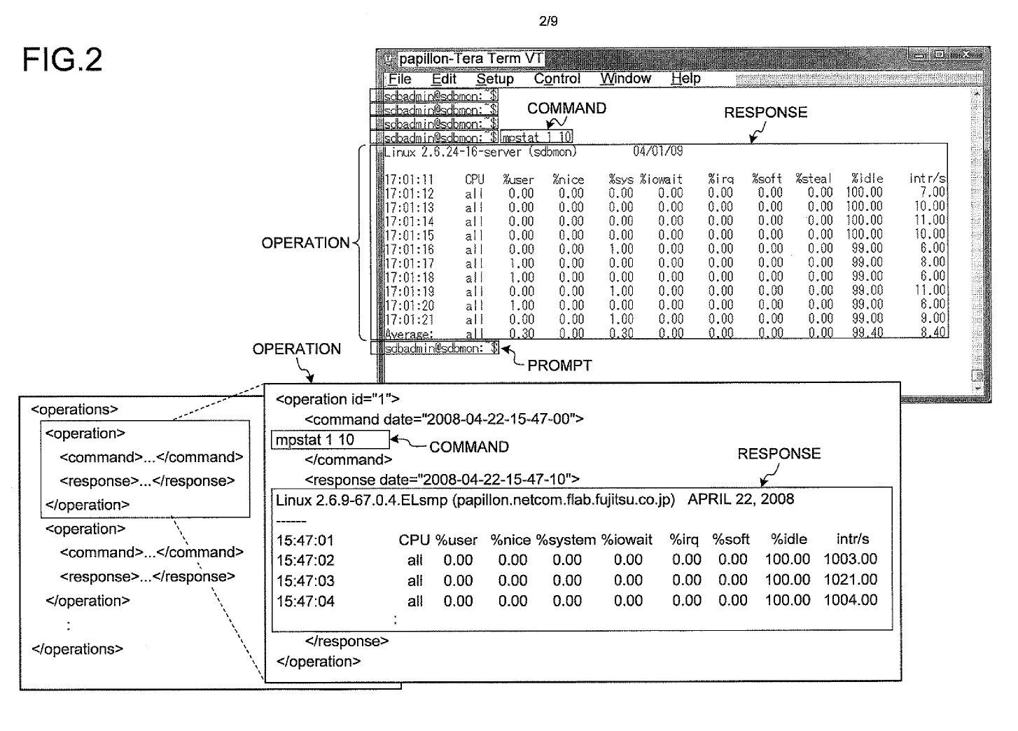

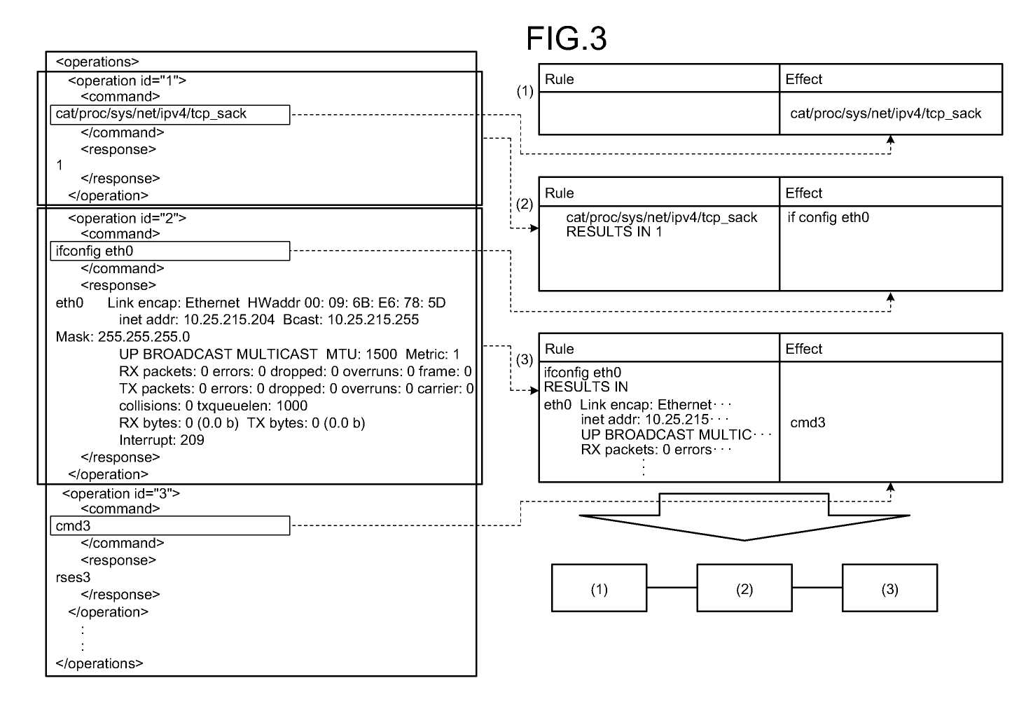

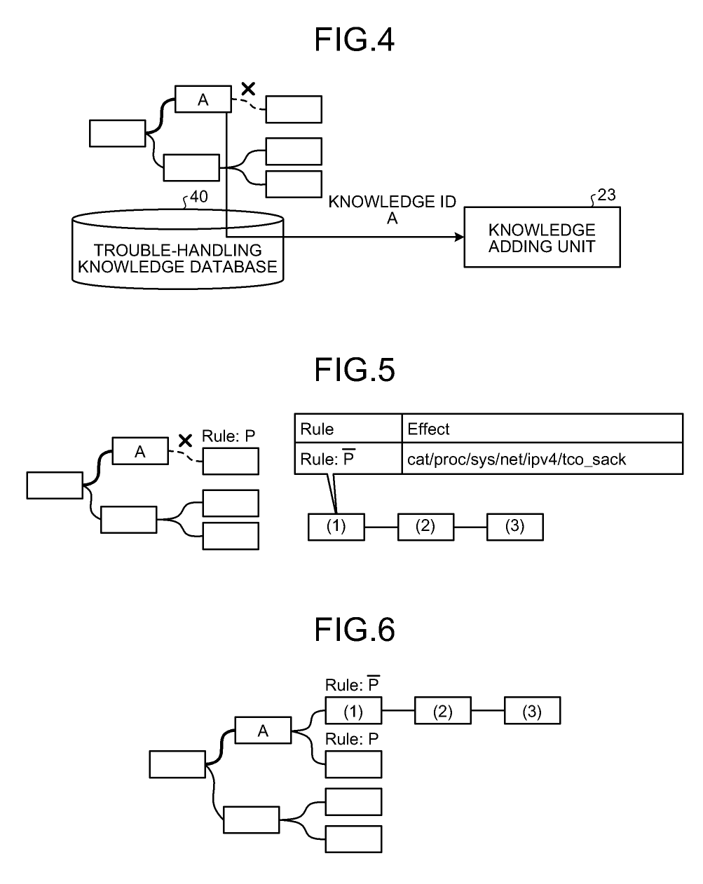

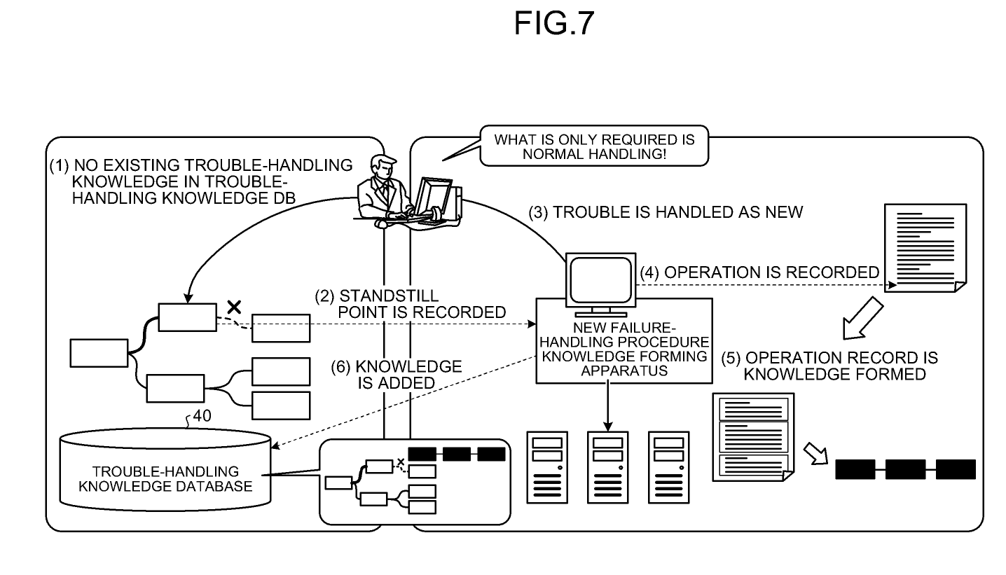

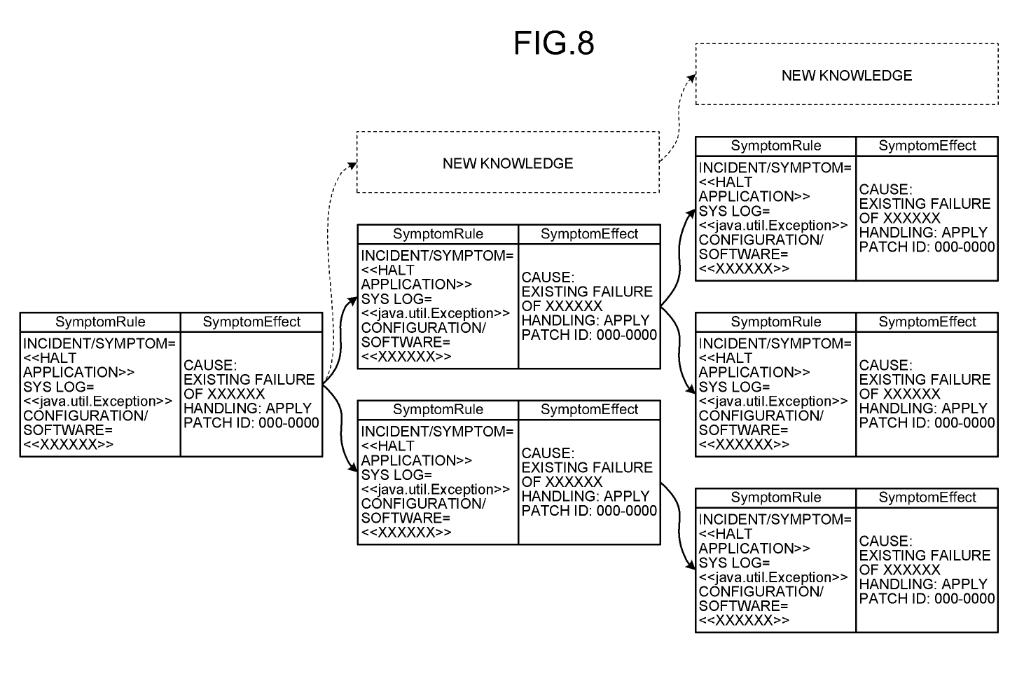

First of all, by using FIGS. 1 to 8, the configuration of a new failure-handling procedure knowledge forming apparatus 10 is explained. FIG. 1 is a block diagram of the configuration of the new failure-handling procedure knowledge forming apparatus 10 according to the first embodiment. FIG. 2 is a drawing for explaining a process of a work-history recording unit. FIG. 3 is a drawing for explaining a process of a work-history knowledge forming unit. FIG. 4 is a drawing for explaining a process of a knowledge adding unit. FIG. 5 is a drawing for explaining a process of the knowledge adding unit. FIG. 6 is a drawing for explaining a process of the knowledge adding unit. FIG. 7 is a drawing for explaining a process of forming a knowledge of a new trouble-handling procedure. FIG. 8 is a drawing for explaining a process of forming a knowledge of a new trouble-handling procedure.

As depicted in FIG. 1, the new failure-handling procedure knowledge forming apparatus 10 includes a controlling unit 20 and a storage unit 30, and is connected to a trouble-handling knowledge database (DB) 40 via a bus or the like. Each of these components is explained below.

The storage unit 30 has stored therein data and programs required for various processing by the controlling unit 20, and includes in particular a work-history storage unit 31 and a handling-knowledge storage unit 32.

The work-history storage unit 31 has stored therein information regarding a history of works performed on an operation terminal. Specifically, from a history of operations of the operation terminal each performed as a handling of a new trouble by an operation manager or the like, a pair of a command and a response is structured as one “operation” to form an operation terminal log, and this log is stored by a work-history storing unit 21, which will be explained further below, in the work-history storage unit 31 (refer to FIG. 2, which will be explained in detail further below).

The handling-knowledge storage unit 32 has stored therein a new trouble-handling knowledge. Specifically, the handling-knowledge storage unit 32 has stored therein a trouble-handling knowledge generated by a work-history knowledge forming unit 22, which will be explained further below (refer to FIG. 3, which will be explained further below in detail).

The controlling unit 20 includes an internal memory for storing programs and necessary data in which various procedures are defined, thereby performing various processing. In particular, the controlling unit 20 includes the work-history storing unit 21, the work-history knowledge forming unit 22, and a knowledge adding unit 23.

The work-history storing unit 21 stores information regarding a history of works performed on the operation terminal in the work-history storage unit 31. Specifically as exemplarily depicted in FIG. 2, the work-history storing unit 21 obtains from the work history a prompt character string indicative of a state in which a command input can be accepted, thereby identifying an operation and a response. The work-history storing unit 21 then structures a pair of the identified “command” and “response” as one “operation” to form an operation terminal log, and stores the structured operation terminal log in the work-history storage unit 31.

The work-history knowledge forming unit 22 generates a new trouble-handling knowledge by using the information regarding the operation history. Specifically as depicted in FIG. 3, the work-history knowledge forming unit 22 reads from the work-history storage unit 31 the information regarding the operation history. Then, by taking a pair of a “command” and a “response” of an immediately previous operation as Rule (or symptom) and a “command” of an operation to be performed next as Effect (or handling), the work-history knowledge forming unit 22 generates a new trouble-handling knowledge.

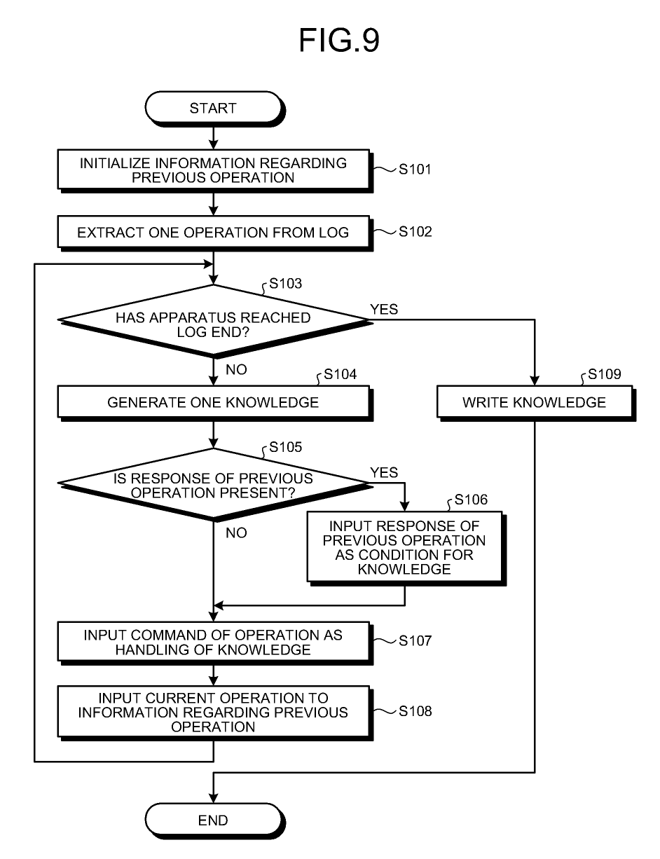

For example, in the example of FIG. 3, as Rule of (2), the work-history knowledge forming unit 22 generates a command “cat/proc/sys/net/ipv4/tcp_sack” and a response “1” of an immediately previous operation. Then, as Rule of (2), the work-history knowledge forming unit 22 generates a command “ifconfig eth0” of an operation to be performed next. A more detailed flow of a process of generating a new trouble-handling knowledge from a work history will be explained further below by using FIG. 9.

The knowledge adding unit 23 adds the generated new trouble-handling knowledge to a point subsequent to a standstill point in the trouble-handling knowledge DB 40. Specifically, as exemplarily depicted in FIG. 4, the knowledge adding unit 23 obtains an IDentification (ID) of a trouble-handling knowledge “A” (for example, a trouble-handling knowledge referred to lastly), which is a standstill point in the trouble-handling knowledge DB 40.

Then, as exemplarily depicted in FIG. 5, the knowledge adding unit 23 extracts Rule of the trouble-handling knowledge in a child direction of the trouble-handling knowledge “A” of the standstill point, and takes a negation of the extracted Rule (in the example of FIG. 5, “Rule: P” as Rule of a head of the generated new pieces of trouble-handling knowledge (in the example of FIG. 5, a trouble-handling knowledge (1)).

Then, as exemplarily depicted in FIG. 6, the knowledge adding unit 23 adds the generated new pieces of trouble-handling knowledge (1) to (3) under the trouble-handling knowledge “A” of the standstill point.

Here, a flow of a series of processes from coming to a standstill in an existing trouble handling to adding to a new trouble-handling knowledge to the trouble-handling knowledge DB 40 is specifically explained by using an example of FIG. 7. As depicted in the drawing, when the operation manager cannot handle a trouble with any existing trouble handling and comes to a standstill (refer to (1) in FIG. 7), the standstill point is recorded (refer to (2) in FIG. 7), and is then handled as a new trouble (refer to (3) in FIG. 7).

The new failure-handling procedure knowledge forming apparatus 10 then records information regarding a history of works performed on an operation terminal in the work-history storage unit 31 (refer to (4) in FIG. 7). Then, the new failure-handling procedure knowledge forming apparatus 10 generates a new trouble-handling knowledge from the work history (refer to (5) in FIG. 7). Then, the new failure-handling procedure knowledge forming apparatus 10 adds the generated new trouble-handling knowledge to a point subsequent to the standstill point in the trouble-handling knowledge DB 40 (refer to (6) in FIG. 7).

That is, as depicted in FIG. 8, for a new trouble that occurred due to introduction of a new product or discovery of a new bug and cannot be handled with any existing trouble-handling knowledge, a new trouble-handling knowledge is automatically added to the trouble-handling knowledge DB 40.

[Process by the New Failure-Handling Procedure Knowledge Forming Apparatus]

Next, by using FIG. 9, a flow of a new trouble-handling procedure knowledge forming process by the new failure-handling procedure knowledge forming apparatus 10 according to the first embodiment is explained. FIG. 9 is a flowchart for explaining a process operation of the new failure-handling procedure knowledge forming apparatus 10 according to the first embodiment.

As depicted in the drawing, the new failure-handling procedure knowledge forming apparatus 10 initializes information regarding the previous operation (step S101) and then extracts one operation from a log (step S102). Then, the new failure-handling procedure knowledge forming apparatus 10 determines whether to have reached a log end (step S103). When determining not to have reached a log end (“No” at step S103), the new failure-handling procedure knowledge forming apparatus 10 generates one new trouble-handling knowledge (step S104), and then determines whether a response of the previous operation is present (step S105).

As a result, when determining that a response of the previous operation is present (“Yes” at step S105), the new failure-handling procedure knowledge forming apparatus 10 inputs the response of the previous operation as a condition for knowledge (step S106). On the other hand, when determining that a response of the previous operation is not present (“No” at step S105), the procedure goes to step S107.

The new failure-handling procedure knowledge forming apparatus 10 then inputs a command of operation as a handling of knowledge (step S107), inputs the current operation to the information regarding the previous operation (step S108), and then returns to step S103, where the new failure-handling procedure knowledge forming apparatus 10 determines whether to have reached a log end (step S103). When determining to have not reached a log end (“No” at step S103), the new failure-handling procedure knowledge forming apparatus 10 repeats the processes at steps S104 through S108.

When determining to have reached a log end (“Yes” at step S103), the new failure-handling procedure knowledge forming apparatus 10 adds the generated new trouble-handling knowledge to the trouble-handling knowledge DB 40 (step S109).

### Effects of the First Embodiment

As explained above, the new failure-handling procedure knowledge forming apparatus 10 generates a new trouble-handling knowledge by using the information regarding the work history, and adds the generated new trouble-handling knowledge. Therefore, a new trouble-handling knowledge can be automatically added to the trouble-handling knowledge DB 40 at little expense in time and effort.

Furthermore, according to the first embodiment, a pair of a command and a response of an immediately previous operation is taken as Rule (or symptom) and a command of an operation to be performed next is taken as Effect (or handling) to generate a new trouble-handling knowledge. Therefore, a new trouble-handling knowledge can be accurately generated from the work history.

Still further, according to the first embodiment, the generated new trouble-handling knowledge is added to a position subsequent to a standstill position of the existing trouble-handling knowledge. Therefore, for a new trouble not stored in the trouble-handling knowledge DB 40, the generated new trouble-handling knowledge can be added to a point subsequent to the standstill point of the existing trouble handling.

As the information regarding the work history, information structured by taking a pair of a command and a response from a history of operations performed by the operation terminal for new trouble handling as one operation is stored in the work-history storage unit 31. Therefore, a new trouble-handling knowledge can be accurately generated from the information regarding the work history stored in the work-history storage unit 31.

### Second Embodiment

The present invention can be implemented with various different modes other than the first embodiment described above. As another embodiment of the present invention, a second embodiment is explained below.

(1) System Configuration, etc.

Each component depicted is conceptual in function, and is not necessarily physically configured as depicted. That is, the specific patterns of distribution and unification of the components are not meant to be restricted to those depicted in the drawings. All or part of the components can be functionally or physically distributed or unified in arbitrary units according to various loads and the state of use. For example, the work-history storing unit 21 and the work-history knowledge forming unit 22 may be unified together.

Furthermore, among the processes explained in the embodiments, all or part of the processes explained as being automatically performed can be manually performed, or all or part of the processes explained as being manually performed can be automatically performed through a known method. For example, when a trouble cannot be handled with any existing trouble handling and the procedure comes to a standstill, the standstill point may be automatically recorded.

(2) Program

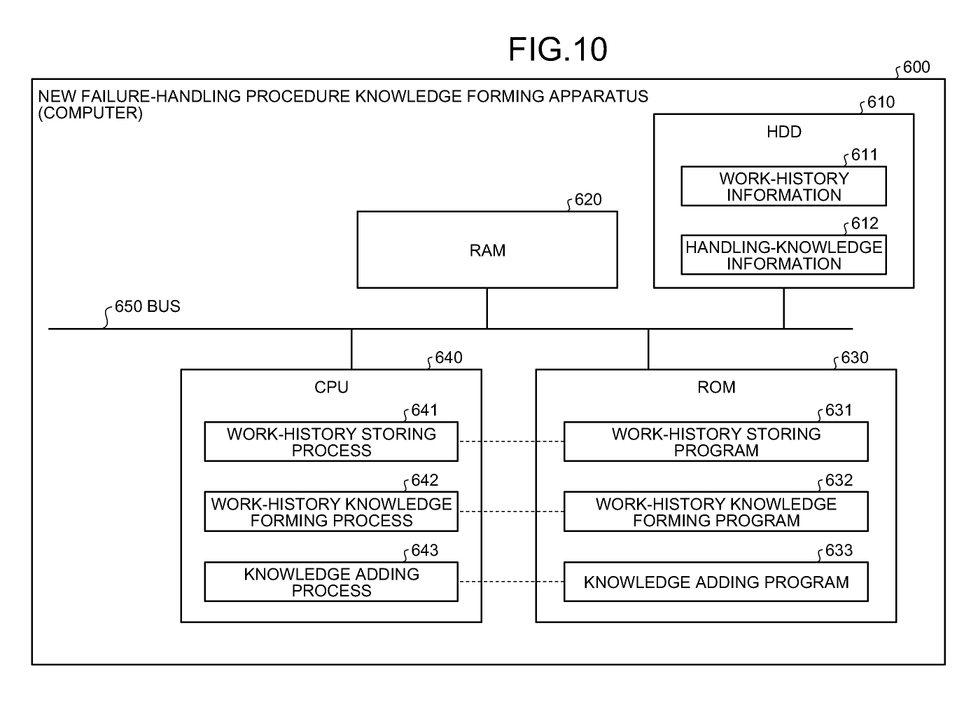

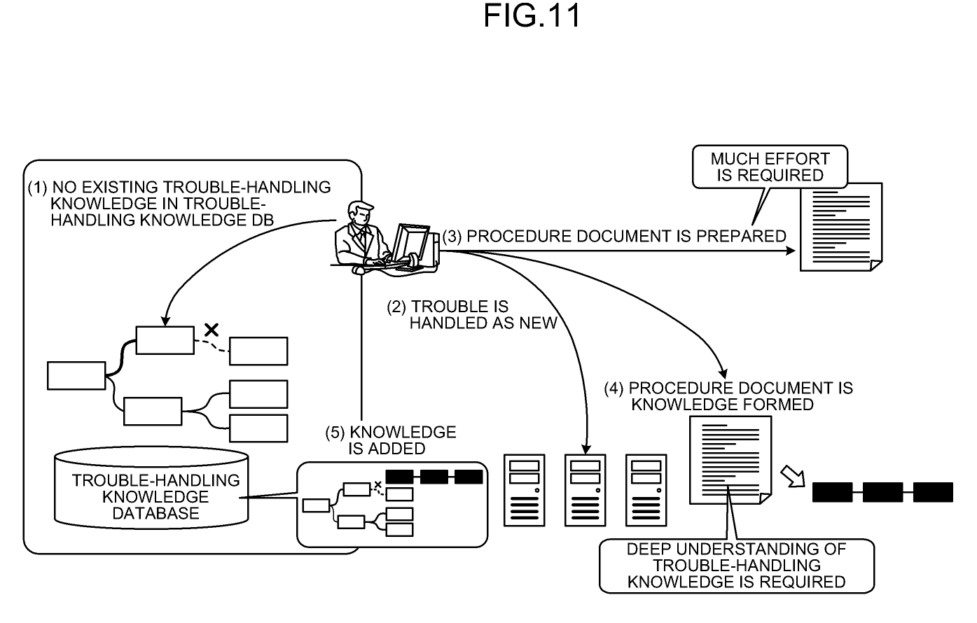

Meanwhile, various processes explained in the embodiment can be achieved by executing a program provided in advance on a computer. Thus, in the following, by using FIG. 10, an example of a computer executing a program having functions similar to those in the embodiment is explained. FIG. 10 is a drawing of a computer that executes a new failure-handling procedure knowledge forming program.

As depicted in the drawing, a computer 600 as a new failure-handling procedure knowledge forming apparatus is configured to have a hard disk drive (HDD) 610, a Random Access Memory (RAM) 620, a Read Only Memory (ROM) 630, and a Central Processing Unit (CPU) 640 connected via a bus 650.

In the ROM 630, a new failure-handling procedure knowledge forming program achieving functions similar to those of the embodiment is stored. That is, as depicted in FIG. 10, a work-history storing program 631, a work-history knowledge forming program 632, and a knowledge adding program 633 are stored in advance. Here, as with the components of the new failure-handling procedure knowledge forming apparatus depicted in FIG. 1, these programs 631 to 633 may be unified or distributed as appropriate.

With the CPU 640 reading these programs 631 to 633 from the ROM 630 for execution, as depicted in FIG. 10, the programs 631 to 633 function as a work-history storing process 641, a work-history knowledge forming process 642, and a knowledge adding process 643, respectively. These processes 641 to 643 correspond to the work-history storing unit 21, the work-history knowledge forming unit 22, and the knowledge adding unit 23 depicted in FIG. 1, respectively.

Also, as depicted in FIG. 10, the HDD 610 is provided with work-history information 611 and handling-knowledge information 612. Note that the work-history information 611 and the handling-knowledge information 612 correspond to the work-history storage unit 31 and the handling-knowledge storage unit 32 depicted in FIG. 1, respectively. The CPU 640 reads the work-history information 611 and the handling-knowledge information 612, stores them in the RAM 620, and then performs processing based on the information stored in the RAM 620.

The apparatus according to an embodiment can easily add a new trouble-handling knowledge to the trouble-handling knowledge database with less time and effort.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A computer-readable storage medium containing instructions that, when executed by a computer, cause the computer to perform:
generating a new trouble-handling knowledge by using information regarding a work history read from a work-history storage unit that stores the information regarding the work history; and
adding the new trouble-handling knowledge to an existing trouble-handling knowledge.

2. The computer-readable storage medium according to claim 1, wherein the generating includes generating the new trouble-handling knowledge, by taking a pair of a command and a response of an immediately previous operation as a symptom and taking a command of an operation to be performed next as a handling.

3. The computer-readable storage medium according to claim 1, wherein the adding includes adding the new trouble-handling knowledge, subsequently to a trouble-handling knowledge that represents a standstill position with an existing trouble handling

4. The computer-readable storage medium according to claim 1, wherein the instructions further cause the computer to perform
storing, in the work-history storage unit as information regarding the work history, information that has structured as one operation a pair of a command and a response from a history of operations performed by an operation terminal where a new trouble handling is performed.

5. A new failure-handling procedure knowledge forming apparatus, comprising:
a work-history knowledge forming unit for generating a new trouble-handling knowledge by using information regarding a work history read from a work-history storage unit that stores the information regarding the work history; and
a knowledge adding unit for adding the new trouble-handling knowledge generated at the work-history knowledge forming unit to an existing trouble-handling knowledge.

6. A method of forming a new failure-handling procedure knowledge, comprising:
generating a new trouble-handling knowledge by using information regarding a work history read from a work-history storage unit that stores the information regarding the work history; and
adding the new trouble-handling knowledge to an existing trouble-handling knowledge.
